(19) United States
(12) Patent Application Publication
(10) Pub. No.: US 2024/0152860 A1
(43) Pub. Date: May 9, 2024

(54) ROUTE MANAGEMENT SYSTEM AND METHOD THEREOF

(71) Applicants: HYUNDAI MOTOR COMPANY, Seoul (KR); KIA CORPORATION, Seoul (KR)

(72) Inventors: Donghee SEOK, Seoul (KR); Jong Bok LEE, Yongin-si (KR); Hee Jin RO, Seoul (KR)

(21) Appl. No.: 18/204,431

(22) Filed: Jun. 1, 2023

(30) Foreign Application Priority Data
Nov. 3, 2022 (KR) 10-2022-0145123

(51) Int. Cl. G06Q 10/0835; G06Q 10/0833; G06Q 50/30; G08G 1/14

(52) U.S. Cl. CPC G06Q 10/08355; G06Q 10/0833; G06Q 50/30; G08G 1/144

(57) ABSTRACT

A route management method includes dividing an area into a plurality of main areas for delivering goods and receiving information where one of the plurality of main areas is set as a delivery area for delivery to a route management server, dividing, by the route management server, the delivery area into a plurality of sub-areas and transmitting information on one or more of the plurality of sub-areas to a user terminal owned by a user performing delivery, calculating, by the route management server, a parking/stop available location in which a vehicle of the user may be parked in the delivery area and transmitting the calculated parking/stop available location to the user terminal, and calculating, by the route management server, a delivery route for delivery in one or more of the plurality of sub-areas and transmitting the calculated delivery route to the user terminal.

### CROSS-REFERENCE TO RELATED APPLICATION(S)

This application claims the benefit of priority to Korean Patent Application No. 10-2022-0145123, filed on Nov. 3, 2022 in the Korean Intellectual Property Office, the disclosure of which is incorporated herein by reference.

### TECHNICAL FIELD

The present disclosure relates to a route management system and method thereof, and more particularly, to a route management system configured for providing an optimized route when delivering cargo such as courier services, and a method thereof.

### BACKGROUND

Generally, as an E-commerce sales market rapidly grows, delivery of goods is speedily increasing, and drivers delivering such goods regularly perform delivery in certain areas. Therefore, delivery drivers have information on moving routes and delivery routes in corresponding areas, but delivery work is not easy for drivers unfamiliar with areas because they do not have much information.

Moreover, a typical navigation system provides information on a route to a destination, but such information is different from an optimal route in performing delivery services. In addition, in the case of an apartment complex, it is not easy for vehicles to enter the complex, resulting in having disadvantages in that it is difficult to use information provided through a navigation system.

### SUMMARY

Various aspects of the present disclosure provide a route management system configured for providing an optimal delivery route to a delivery driver specialized in delivery work, and a method thereof.

Additional aspects of the present disclosure will be set forth in part in the description which follows and, in part, will be obvious from the description, or may be learned by practice of the disclosure.

In accordance with an embodiment of the present disclosure, a route management method includes dividing a certain area into a plurality of main areas for delivering goods and receiving information in which one of the plurality of main areas is set as a delivery area for delivery to a route management server, dividing, by the route management server, the set one of the plurality of main areas into a plurality of sub-areas and transmitting information on one or more of the plurality of sub-areas to a user terminal owned by a user performing delivery, calculating, by the route management server, a parking/stop available location in which a vehicle of the user may be parked in the set one of the plurality of main areas and transmitting the calculated parking/stop available location to the user terminal, and calculating, by the route management server, a delivery route for delivery in one or more of the plurality of sub-areas and transmitting the calculated delivery route to the user terminal.

The route management method may further include updating information on the set delivery area among the plurality of main areas in the route management server, wherein the transmitting of information on one or more of the plurality of sub-areas includes transmitting the updated information.

The updated information may include information on other users who are delivering in the set delivery area among the plurality of main areas.

The route management method may further include receiving, by the route management server, information on a parking/stop unavailable location in the set one area of the plurality of main areas, wherein the calculating of the parking/stop available location is calculated by using information on the parking/stop unavailable location.

The information on the parking/stop available location may be transmitted from the user terminal.

The calculating of the delivery route may be calculated by using information on an amount of items to be delivered.

The calculating of the parking/stop available location may be calculated by using one or more of information on a delivery time of the user, information on surrounding environments, and information on an amount of items to be delivered.

The calculating of the parking/stop available location may be calculated by using a location where a gradient of a road is less than or equal to a predetermined angle as a fixed condition.

The calculating of the parking/stop available location may be calculated by using information on a delivery time of the user, information on surrounding environments, and information on an amount of the items to be delivered prior to the fixed condition.

The route management server may track a location of the user terminal.

The route management method may further include transmitting, by the route management server, when the delivery is completed in one or more set area of the plurality of sub-areas, information on another one or more of the plurality of sub-areas to the user terminal.

The parking/stop available location may be calculated by using information on a flat position on a road.

In accordance with another embodiment of the present disclosure, a route management system includes a map information provider including map information for a certain area in order to deliver goods, a communicator configured to communicate with at least one of a user terminal owned by a user performing delivery and a delivery management server configured to manage goods delivery, and a calculator configured to calculate information on a parking/stop available location where a vehicle of the user may use and information on a delivery route of the user, so as to provide the information to the user terminal, wherein the calculator is further configured to divide the certain area into a plurality of main areas, set one of the plurality of main areas as a delivery area, and calculate the parking/stop available location where the vehicle of the user may use in the set delivery area.

The calculator may divide one of the plurality of main areas into a plurality of sub-areas, and calculate the delivery route for delivery in one or more of the plurality of sub-areas.

The communicator may receive information on other users who are delivering in the set delivery area among the plurality of main areas from the delivery management server,

The communicator may receive information on a parking/stop unavailable location from at least one of the delivery management server and the user terminal, and the calculator may perform the calculation on the parking/stop available location by using the information on the parking/stop unavailable location.

The calculation on the delivery route may perform by using information on an amount of items to be delivered.

The calculation on the parking/stop available location may perform by using one or more of information on a delivery time of the user, information on surrounding environments, and information on an amount of items to be delivered.

### BRIEF DESCRIPTION OF THE DRAWINGS

These and/or other aspects of embodiments of the disclosure will become apparent and more readily appreciated from the following description of the embodiments, taken in conjunction with the accompanying drawings, in which:

FIG. 1 is a block diagram illustrating a route management system according to an embodiment of the present disclosure;

FIG. 2 is a view illustrating an example of dividing regions provided by the route management system according to an embodiment of the present disclosure into a main region;

FIG. 3 is a view illustrating a recommended route of a sub-zone in the route management system according to an embodiment of the present disclosure; and

FIG. 4 is a flowchart illustrating a route management method according to an embodiment of the present disclosure.

### DETAILED DESCRIPTION

Reference will now be made in detail to the embodiments of the disclosure, examples of which are illustrated in the accompanying drawings, wherein like reference numerals refer to like elements throughout. This specification does not describe all elements of the disclosed embodiments and detailed descriptions of what is well known in the art or redundant descriptions on substantially the same configurations have been omitted. The terms ‘part’, ‘module’, ‘member’, ‘block’ and the like as used in the specification may be implemented in software or hardware. Further, a plurality of ‘part’, ‘module’, ‘member’, ‘block’ and the like may be embodied as one component. It is also possible that one ‘part’, ‘module’, ‘member’, ‘block’ and the like includes a plurality of components.

Throughout the specification, when an element is referred to as being “connected to” another element, it may be directly or indirectly connected to the other element and the “indirectly connected to” includes being connected to the other element via a wireless communication network.

Also, it is to be understood that the terms “include” and “have” are intended to indicate the existence of elements disclosed in the specification, and are not intended to preclude the possibility that one or more other elements may exist or may be added.

Throughout the specification, when a member is located “on” another member, this includes not only when one member is in contact with another member but also when another member is present between the two members.

The terms first, second, and the like are used to distinguish one component from another component, and the component is not limited by the terms described above.

An expression used in the singular encompasses the expression of the plural, unless it has a clearly different meaning in the context.

The reference numerals used in operations are used for descriptive convenience and are not intended to describe the order of operations and the operations may be performed in a different order unless otherwise stated.

Hereinafter, embodiments of the disclosure will be described in detail with reference to the accompanying drawings.

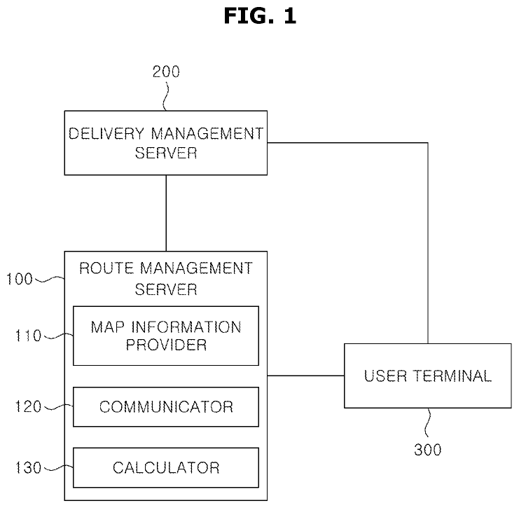

Referring to FIGS. 1 to 3, a route management system 10 according to an embodiment of the present disclosure will be described. The route management system 10 according to an embodiment of the present disclosure may guide an optimal location for parking a vehicle and provide a delivery route when delivering goods. The route management system 10 may include a route management server 100, a delivery management server 200, and a user terminal 300.

In an embodiment of the present disclosure, the vehicle may include an internal combustion engine vehicle or an eco-friendly vehicle through which a user may deliver goods, and may also include a personal mobility such as an electric bicycle, a kickboard, and a bicycle, and the like. Such vehicles may be equipped with a gyro sensor or the like to identify that the vehicle is parked at an inclined position.

The route management server 100 may communicate with the delivery management server 200 to calculate information on a region to be delivered and an area where a user may park a vehicle in real time and guide thereto. The route management server 100 may receive information regarding a goods delivery to be delivered by the user and information about a delivery area from the delivery management server 200, and guide the user thereto. At this time, the route management server 100 may directly transmit corresponding information to the user terminal 300, but is not limited thereto. Alternatively, the route management server 100 may transmit the corresponding information through the delivery management server 200. To this end, the route management server 100 may include a map information provider 110, a communicator 120 and a calculator 130.

The map information provider 110 may include map information about a region to which a user intends to deliver goods. The map information provider 110 may include information on a map provided by a navigation system, slope information of a road, precise location information on surrounding environments of a road, and the like. The Information on surrounding environments of the road may include information about locations of a playground, a daycare center, a shopping mall, and a building in apartment.

Furthermore, the map information provider 110 may divide and set a plurality of main areas for delivery on the map through map information, and further divide the plurality of main areas into a plurality of sub-areas and set.

The communicator 120 may communicate with the delivery management server 200 and the user terminal 300. The communicator 120 may receive information about goods for delivery from a delivery information server, and may receive information about a request for a delivery map from the user terminal 300. Furthermore, the communicator 120 may transmit information on a parking location of the vehicle and information on a delivery route to the delivery information server and the user terminal 300.

The communicator 120 may communicate with the delivery management server 200 and the user terminal 300 by using an Internet network or a mobile communication network. In addition, the communicator 120 may communicate with the delivery management server 200 through an application programming interface (API).

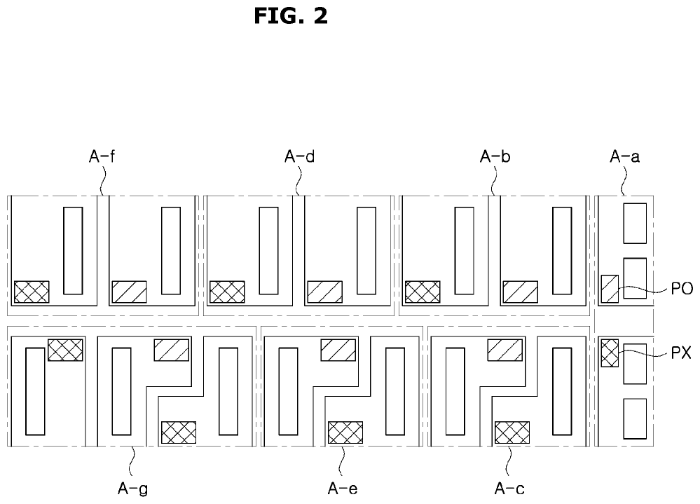

The calculator 130, based on information about a delivery territory of goods from the delivery management server 200 through the communicator 120, as shown in FIG. 2, performs calculations for dividing the delivery territory from the map information of the map information provider 110 into the plurality of main areas, and further dividing the main areas into the plurality of sub-areas. FIG. 2 is a view exemplarily illustrating that a main area A is divided into 7 sub-areas in the map information.

Herein, the main area may be, for example, an area divided by geo-fencing, or may be a specific farm or complex divided by geo-fencing. The main area may be managed by being given a unique number (e.g., ID), and when the main area is divided into the plurality of sub-areas, each sub-area may be assigned a unique number of a lower layer and managed.

Furthermore, the calculator 130 may calculate a parking/stop available location PO and a parking/stop unavailable location PX in the plurality of sub-areas. The calculator 130 may calculate the PO and the PX in real time in consideration of a time of day, environments around a road, and a slop of a road, and the like. For example, the calculator 130 may calculate in such a way that a location adjacent to a road used as a way to and from school or kindergarten during pick-up and drop-off times for schools and kindergartens is set as the PX. In addition, the calculator 130 may calculate in such a way that a location where the gradient of a road is not flat is set as the PX.

As such, when calculating the parking (including stop) available location of the vehicle, the calculator 130 sets a flat position as possible in consideration of the gradient of the road as the parking available location, which is to prevent items stored in the vehicle from being damaged when the vehicle for delivery is parked at an angle.

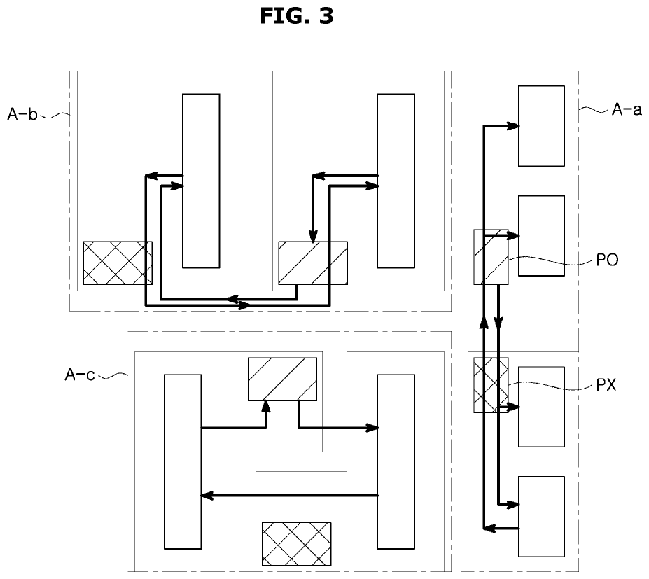

Furthermore, when the calculator 130 may calculate a moving route of the vehicle in the plurality of sub-areas, and may calculate an optimal route when the vehicle moves from one sub-area to another sub-area. In addition, as shown in FIG. 3, the calculator 130 may calculate a delivery route of goods within the sub-area centered on the parking available location.

In other words, the calculator 130 may calculate a route that may optimally perform goods delivery within one main area. For example, in FIG. 2, the calculator 130 may calculate a route to deliver goods while the vehicle moves in the order of zone A-a, zone A-b, zone A-d, zone A-f, zone A-g, zone A-e, and zone A-c. Furthermore, the calculator 130 may calculate an optimal route through which the user may deliver goods in a state where the vehicle is parked in the parking available location. Herein, the delivery route within the sub-area is a route through which the user may deliver goods by walking rather than moving by vehicle.

In addition, the calculator 130 may receive information on the sub-area from the user terminal 300 through the communicator 120, and utilize the received information on the sub-area to calculate the parking available locations, the parking unavailable locations, and the delivery routes for goods in real time. When the user inputs conditions of on-site to the user terminal 300 in the process of delivering goods, the information input is transmitted to the calculator 130 through the communicator 120 of the route management server 100, and then the calculator 130 may calculate the parking available locations, the parking unavailable locations, and the goods delivery routes in real time using the corresponding information.

The parking available locations, the parking unavailable locations, and the goods delivery routes calculated in real time by the calculator 130 may be used next time when the user delivers goods or any other user delivers goods.

For example, when emergency construction is carried out at a location marked as a parking available sector while the user is delivering goods in zone A-b, as the user inputs the corresponding information into the user terminal 300, 100 the corresponding information may be transmitted to the communicator 120 of the route management server. As a result, the calculator 130 may calculate the parking available locations, the parking unavailable locations, and the goods delivery routes in zone A-b based on the information transmitted through the communicator 120.

The delivery management server 200 is a server configured for managing information for goods delivery and providing delivery information to users. The delivery management server 200 may be, for example, a transportation management system (TMS) or a forwarding management system (FMS). The delivery management server 200 may be provided in plurality. In an embodiment, the plurality of delivery management servers 200 may be a plurality of delivery management servers 200 managed by one company, or may be each delivery management server 200 managed by a plurality of companies.

When the main areas are set by the route management server 100, the delivery management server 200 may manage routes for the corresponding main areas. In other words, the delivery management server 200 may set moving routes between the main areas when the region for delivering goods is divided and set into the plurality of main areas. For example, when the main area is set to areas A, B and C, the delivery management server 200 may set the delivery order for areas A, B and C to area A, area C, and area B in order, and accordingly set the moving routes between the main areas.

Furthermore, the delivery management server 200 may continuously communicate with the user terminal 300. The delivery management server 200 may transmit information regarding goods to be delivered to the user terminal 300, and in response to the user delivering the goods, receive information regarding the delivery result from the user terminal 300.

In addition, the delivery management server 200 may track location information of the user terminal 300 in real time. Accordingly, the delivery management server 200 may identify the area in which the user is performing delivery work through the user terminal 300.

The user terminal 300 may communicate with the route management server 100 and the delivery management server 200, and display various information for goods delivery. The user terminal 300 may be a smart phone, a tablet personal computer (PC), or the like. The user terminal 300 may receive information related to goods delivery from the delivery management server 200 and display the information so that the user may identify. Moreover, the user terminal 300 may receive information on a moving route within the main area and a moving route within the sub-area from the route management server 100 and display the information so that the user may identify.

In addition, the user terminal 300 may be input by the user to information on emergency construction in an area to be delivered or information on pick-up and drop-off times for schools and kindergartens. The user terminal 300 may transmit the information input to the delivery management server 200, and the delivery management server 200 may transmit the corresponding information to the route management server 100, but is not limited thereto. The user terminal 300 may transmit the corresponding information to the route management server 100 as needed.

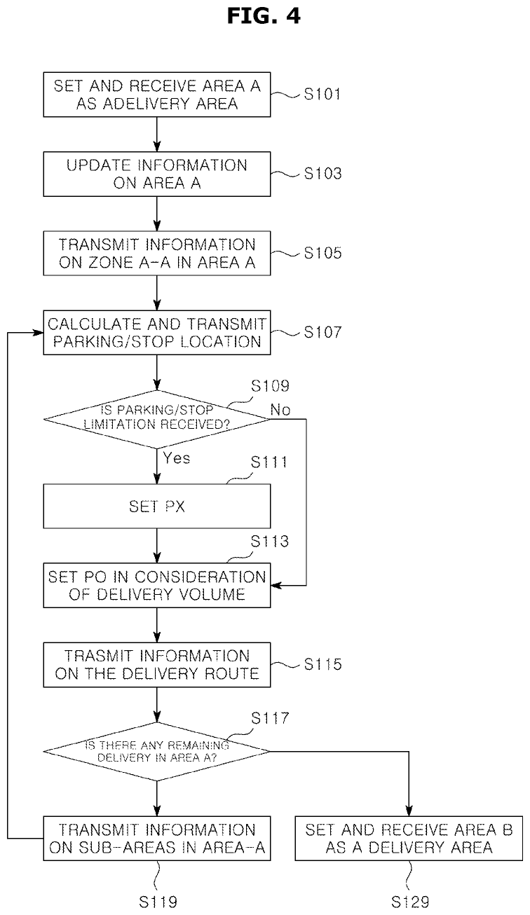

Referring to FIG. 4, a route management method according to an embodiment of the present disclosure will be described. The route management method according to the embodiment of the present disclosure will be described with reference to the drawings shown in FIGS. 1 to 3.

Area A as a delivery area is set and received at S101. The route management server 100 receives information from the delivery management server 200 in which area A is set as an area for goods delivery. Area A is one of the main areas for delivery and is one of the plurality of main areas. In the instant step, the delivery management server 200 may inform the user terminal 300 that area A is set as a delivery area in the same way.

Information on area A is updated at S103. The route management server 100 updates all information about area A, which is the main area. The updated information updates all delivery information in the plurality of sub-areas within area A, which is the main area. In other words, the route management server 100 updates information on all users within area A, which is the main area, by updating information on other users as well as the user who delivers the goods.

In other words, the route management server 100 may identify routes along which a plurality of users moving in area A are moved through the user terminal 300 possessed by each user.

Thereafter, as the delivery area is set to area A, which is the main area, the user enters zone A-a, which is the first zone of area A.

Information on the updated zone A-a in area A is transmitted at S105. The route management server 100 transmits information on zone A-a, which is a sub-area of area A that is the main area, to the delivery management server 200 or the user terminal 300. Herein, the route management server 100 collects information on a plurality of users moving in area A that is the main area, and transfers the collected information on the plurality of users to the delivery management server 200 or the user terminal 300.

As a result, the user may check information on the moving routes of other users who have already entered the zone A-a through the user terminal 300.

The parking/stop positions are calculated and transmitted at S107. The route management server 100 calculates the parking/stop available location PO and the parking/stop unavailable location (PX) in area A that is the main area. Herein, the route management server 100 calculates the PO where the vehicles may be parked and PX where vehicles may not be parked in consideration of a real-time position of all users moving in area A. At this time, the route management server 100 calculates the PO and the PX in consideration of user's movement time, environments around a road, and a slope of a road.

Furthermore, the route management server 100 transmits information on the calculated PO and PX to one or more of the delivery management server 200 and the user terminal 300. When the route management server 100 transmits information on the calculated PO and PX to the delivery management server 200, the delivery management server 200 transmits the corresponding information to the user terminal 300.

Whether parking/stop limitation is received is determined at S109. The route management server 100 determines whether information indicating that parking/stop is restricted for the PO is received. Alternatively, the route management server 100 determines whether new information about the PX is received. In the instant step, information received by the route management server 100 may be received from the delivery management server 200 or the user terminal 300.

The PX is set at S111. In response to the information on the parking/stop limitation being received, in S109, the route management server 100 sets the corresponding location as the PX. The location set as the PX may be a case where emergency construction is carried out, and may be a location where there are relatively many infants and toddlers, such as a playground or a kindergarten. Alternatively, it may be a location adjacent to a road used as a way to and from school or kindergarten during pick-up and drop-off times for schools and kindergartens

The PO is selected in consideration of delivery volume at S113. The route management server 100 performs a calculation for selecting the PO where the vehicle may be parked in area A that is the main area, in consideration of the amount of goods to be delivered by the user when the PX is set. In other words, the route management server 100 may select the PO in order to park the vehicle at one PO formed by grouping some of the plurality of sub-areas as necessary, even if area A that is the main area is divided into the plurality of sub-areas.

Furthermore, the route management server 100 may select the plurality of parking/stop available locations within the main area so that the user selects one of the plurality of selected PO.

To this end, the route management server 100 may select the plurality of POs based on previously accumulated data, and as far as possible, select a non-sloping flat position (e.g., a position where a slope angle of a road is within a predetermined range, 0 degrees or more and 10 degrees or less) as the PO. Furthermore, the route management server 100 may receive information on the amount of goods to be delivered by the user from the delivery management server 200 and select a location adjacent to a location with a relatively large delivery volume as the PO. Furthermore, the route management server 100 may select the PO in consideration of a delivery time of the location to be delivered and surrounding environments of the1 road. Herein, the route management server 100 may select the PO by giving priority to delivery time information, surrounding environment information, and delivery volume rather than a gradient condition of the road. Because the gradient of the road has a small change over time, the priority may be lower than conditions that change in time series.

Alternatively, the route management server 100 may provide information on the quantity of goods to be delivered at each PO while providing information on the plurality of POs.

In the instant step, the route management server 100 may directly transmit information on the PO to the user terminal 300, but is not limited thereto, and may transmit the information on the PO to the user terminal 300 via the delivery management server 200.

Furthermore, in the instant step, in response to the information on the parking/stop limitation is not received in S109, the PO may be selected without going through S111.

Information on the delivery route is transmitted at S115. The route management server 100 calculates the PO where the user's vehicle may be parked, and then calculates delivery route information through which the user may deliver the goods. The delivery route information for goods delivery in the route management server 100 may exemplarily calculate a route for delivering goods on foot, as shown in FIG. 3.

The route management server 100 may set a route for delivery in one sub-area, but is not limited thereto, and may calculate a route for delivery across the plurality of sub-areas. As such, the route management server 100 may calculate a route for delivery in a state where the vehicle is parked at one location when setting the route for delivery across the plurality of sub-areas.

Whether there is any remaining delivery in area A is identified at S117. The route management server 100 identifies whether items to be delivered in area A that is the main area remains. The route management server 100 may receive information from the delivery management server 200 to identify whether or not there is any remaining delivery, or receive information through the user terminal 300.

Information on sub-areas in area A is transmitted at S119. Upon identified that there is an area left to deliver items to area A that is the main area, the route management server 100 transmits information on other sub-areas in area A to the user terminal 300. In the instant step, information not on the sub-zone transmitted in S105 but on other sub-zones is transmitted to the user terminal 300.

Area B as a delivery area is set and received at S129. The route management server 100 receives information in which the main area, not area A but area B, which is another main area, is set as an area for goods delivery. In other words, when delivery to one main area is completed through S101 to S119, the delivery management server 200 then sets a delivery area for delivery to another main area, and sets the set information to the route management server 100.

A safe driving index is added to the user when delivery is completed along the delivery route provided by the route management server 100 while the user is parked and stopped at one of the POs provided by the route management server 100. In other words, the route management server 100 may identify the location of the user terminal 300 and the delivery route, through the delivery management server 200 or directly by identifying the location of the user terminal 300. Accordingly, the route management server 100 may set and provide the safe driving index when the user performs delivery along the provided PO and the delivery route, and provide a reward according to the safe driving index.

As is apparent from the above, various embodiments of the disclosure may increase, in the case of performing delivery work, delivery efficiency by utilizing the characteristic that the delivery work is repeatedly performed in a specific area.

Furthermore, various embodiments of the disclosure may divide the delivery area into the main areas and the sub-areas, and calculate the delivery route in the sub-area, thereby increasing a calculation speed in the server, and moreover may perform stably delivery work by providing a location where the vehicle may be parked/stopped in real time.

Furthermore, various embodiments of the disclosure may prevent a safety accident from occurring in a specific area by providing information on a parking/stop location in real time.

On the other hand, the above-described embodiments may be implemented in the form of a recording medium storing instructions executable by a computer. The instructions may be stored in the form of program code. When the instructions are executed by a processor, a program module is generated by the instructions so that the operations of the disclosed embodiments may be carried out. The recording medium may be implemented as a computer-readable recording medium.

The computer-readable recording medium includes all types of recording media storing data readable by a computer system. Examples of the computer-readable recording medium include a Read Only Memory (ROM), a Random Access Memory (RAM), a magnetic tape, a magnetic disk, a flash memory, an optical data storage device, or the like.

Although embodiments of the disclosure have been shown and described, it would be appreciated by those having ordinary skill in the art that changes may be made in these embodiments without departing from the principles and spirit of the disclosure, the scope of which is defined in the claims and their equivalents.

What is claimed is:

1. A route management method, comprising:
dividing, by a calculator, an area into a plurality of main areas for delivering goods and receiving information, wherein one of the plurality of main areas is set as a delivery area for delivery to a route management server;
dividing, by the route management server, the delivery area into a plurality of sub-areas, and transmitting information on one or more of the plurality of sub-areas to a user terminal owned by a user performing delivery;
calculating, by the route management server, a parking or stop available location, wherein a vehicle of the user may be parked in the delivery area, and transmitting the calculated parking and stop available location to the user terminal; and
calculating, by the route management server, a delivery route for delivery in one or more of the plurality of sub-areas, and transmitting the calculated delivery route to the user terminal.

2. The route management method of claim 1, further comprising updating information on the delivery area in the route management server,
wherein the transmitting of information on one or more of the plurality of sub-areas includes transmitting the updated information.

3. The route management method of claim 2, wherein the updated information includes information on other users who are delivering in the delivery area.

4. The route management method of claim 1, further comprising receiving, by the route management server, information on a parking or stop unavailable location in the delivery area of the plurality of main areas;
wherein the calculating of the parking or stop available location is calculated by using information on the parking or stop unavailable location.

5. The route management method of claim 4, wherein the information on the parking or stop available location is transmitted from the user terminal.

6. The route management method of claim 1, wherein the calculating of the delivery route is calculated by using information on an amount of items to be delivered.

7. The route management method of claim 1, wherein the calculating of the parking or stop available location is calculated by using one or more of information on a delivery time of the user, information on surrounding environments, and information on an amount of items to be delivered.

8. The route management method of claim 1, wherein the calculating of the parking or stop available location is calculated by using a location where a gradient of a road is less than or equal to a predetermined angle as a fixed condition.

9. The route management method of claim 8, wherein the calculating of the parking or stop available location is calculated by using information on a delivery time of the user, information on surrounding environments, and information on an amount of items to be delivered prior to the fixed condition.

10. The route management method of claim 1, wherein the route management server tracks a location of the user terminal.

11. The route management method of claim 1, further comprising transmitting, by the route management server, when the delivery is completed in one or more areas of the plurality of sub-areas, information on another one or more of the plurality of sub-areas to the user terminal.

12. The route management method of claim 1, wherein the parking or stop available location is calculated by using information on a flat position on a road.

13. A route management system, comprising:
a map information provider including map information for an area in order to deliver goods;
a communicator configured to communicate with at least one of a user terminal owned by a user performing delivery and a delivery management server configured to manage delivery of goods; and
a calculator configured to calculate information on a parking or stop available location available to a vehicle of the user, and information on a delivery route of the user, to provide the information on the parking or stop available location to the user terminal;
wherein the calculator is further configured to divide the area into a plurality of main areas, set one of the plurality of main areas as a delivery area, and calculate available parking or stop available location for the vehicle of the user in the delivery area.

14. The route management system of claim 13, wherein the calculator is further configured to divide one of the plurality of main areas into a plurality of sub-areas, and to calculate the delivery route for delivery in one or more of the plurality of sub-areas.

15. The route management system of claim 13, wherein the communicator is further configured to receive information on other users who are delivering in the delivery area from the delivery management server.

16. The route management system of claim 13, wherein:
the communicator is further configured to receive information on a parking or stop unavailable location from at least one of the delivery management server and the user terminal; and
the calculator is further configured to perform the calculation on the parking or stop available location by using the information on the parking or stop unavailable location.

17. The route management system of claim 14, wherein the calculation on the delivery route is performed by using information on an amount of items to be delivered.

18. The route management system of claim 13, wherein the calculation on the parking or stop available location is performed by using one or more of information on a delivery time of the user, information on surrounding environments, and information on an amount of items to be delivered.
